(19) United States
(12) Patent Application Publication
(10) Pub. No.: US 2021/0288675 A1
(43) Pub. Date: Sep. 16, 2021

(54) Adjustable Multi-band Planar Antenna

(71) Applicant: Innovation Sound Technology Co., LTD., Guangdong (CN)

(72) Inventors: Shun Ming YUEN, Guangdong (CN); Wai Yin MUNG, Guangdong (CN); Ka Ming WU, Guangdong (CN)

(21) Appl. No.: 16/631,053

(22) PCT Filed: Dec. 6, 2018
(86) PCT No.: PCT/CN2018/119497

§ 371 Date: Jan. 14, 2020

(30) Foreign Application Priority Data
Dec. 3, 2018 (CN) 201822007694.8

(51) Int. Cl. H04B 1/00; H01Q 9/04; H01Q 1/48

(52) U.S. Cl. CPC H04B 1/006; H01Q 1/48; H01Q 9/0442

(57) ABSTRACT

The utility model discloses an adjustable multi-band planar antenna, which comprises a ground plane, a resonance branch A, and a resonance branch B. The three components are all disposed on the top surface of a PCB. The said resonance branch A and resonance branch B assume an “L” shape. The planar antenna in the utility model comprises two resonance branches, which enables the antenna to support multiple bands and multiple systems (such as GSM, NB-IoT, GPS, WCDMA, LTE, Bluetooth). The antenna can perform frequency tuning in a high frequency band or a low frequency band, so that it obtains better transmission and reception effects at a specific frequency.

### FIELD OF THE INVENTION

The utility model relates to the technical field of wireless communication, in particular to an adjustable multi-band planar antenna.

### BACKGROUND OF THE INVENTION

The Internet of Things (IoT) refers to the interconnection and exchange of data between devices/sensors. At present, with an explosive growth of the Internet of Things technology, more and more practical applications can be found in many fields, including security, asset tracking, agriculture, smart metering, smart cities and smart homes, etc.

IoT applications place specific requirements, such as long distances, low data rates, low energy consumption, and cost effectiveness. Widely-applied short-range radio technologies (for example, ZigBee, Bluetooth) are not suitable for scenarios requiring long-distance transmission. Solutions based on cellular communications (such as, 2G, 3G, and 4G) can provide a greater coverage, but they consume too much device energy. Therefore, the current solution integrates long- and short-range radio technologies (for example, ZigBee, Bluetooth, and cellular communications, such as 2G, 3G, and 4G) to work together. As a result, a multi-band antenna is required for both technologies, and additionally for transmission and reception.

### Content of the Utility Model

The present invention aims to provide an adjustable multi-band planar antenna to solve the problems presented in the Background of the Invention above.

To achieve the above goal, the present utility model provides the following technical proposals: An adjustable multi-band planar antenna comprising a ground plane, a resonance branch A, and a resonance branch B, wherein the three components are all disposed on the top surface of a PCB, and the resonance branch A and resonance branch B assume an “L” shape.

As a further proposal of the present utility model, the said four sets of tuning circuits (4) are located between the resonance branch A (2), and the resonance branch B (3).

As a further proposal of the present utility model, the said tuning circuit (4) is of a radio frequency switching circuit.

As a further proposal of the present utility model, a circuit is provided at the bottom of the said ground plane

Compared with the prior art, the beneficial effects of the present utility model are as follows:
1) The planar antenna in the utility model comprises two resonance branches, which enables the antenna to support multiple bands and multiple systems (such as GSM, NB-IoT, GPS, WCDMA, LTE, Bluetooth);
2) The antenna can perform frequency tuning in a high frequency band or a low frequency band, so that it can obtain better transmission and reception effects at a specific frequency.

### BRIEF INTRODUCTION OF THE DRAWINGS

FIG. 1 is a schematic structural diagram of embodiment 1 in the present utility model.

FIG. 2 is a diagram showing the S-parameter (S₁₁) simulation and test results of embodiment 1 in the present utility model.

FIG. 3 is a schematic structural diagram of embodiment 2 in the present utility model.

FIG. 4 is a diagram showing the S-parameter (S₁₁) simulation results of embodiment 2 in the present utility model.

### DETAILED DESCRIPTION OF THE PREFERRED EMBODIMENTS

The technical proposal in the embodiments of the utility model will be clearly and completely described as follows with reference to the drawings in the embodiments of the utility model. Obviously, the described embodiments are only a part of the embodiments in the present utility model, rather than all the embodiments. Based on the embodiments in the present utility model, all other embodiments obtained by those having ordinary skill in the art without making any creative work belong to the protection scope of the present utility model.

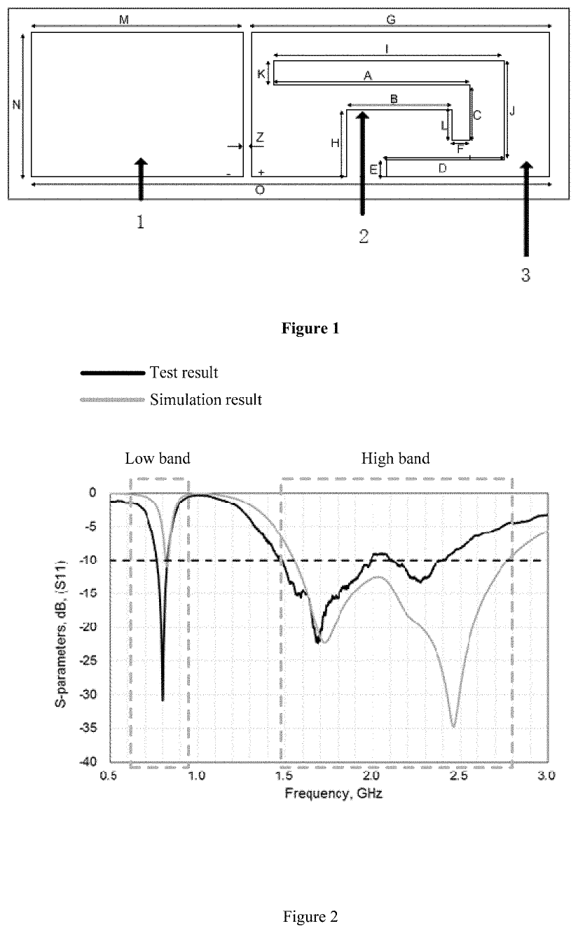

With reference to FIGS. 1 and 2, embodiment 1 provides an adjustable multi-band planar antenna, which comprises a ground plane 1, a resonance branch A (2) and a resonance branch B (3). The ground plane (1), the resonance branch A (2) and the resonance branch B (3) are arranged on the top surface of a PCB. A circuit is arranged on the bottom of the ground plane (1). The said resonance branch A (2) and resonance branch B (3) assume an “L” shape. Its dimension parameters are shown in Table 1.

TABLET 1
Dimension parameters of the resonance branch
A (2) and the resonance branch B (3)

| Parameter | Size (mm) |
|---|---|
| A | 33.2 |
| B | 17.7 |
| C | 9.1 |
| D | 20.1 |
| E | 3.4 |
| F | 3.0 |
| G | 51.0 |
| H | 12.1 |
| 1 | 39.0 |
| J | 16.7 |
| K | 4.4 |
| L | 15.5 |
| M | 36.0 |
| N | 25.0 |
| O | 88.0 |
| Z | 1.0 |

FIG. 2 is a diagram showing the S-parameter (S₁₁) simulation and test results of the adjustable multi-band planar antenna. As can be seen from FIG. 2, since the antenna supports the low band and high band region, the frequency of the low band can be designed from the length of the resonance branch B (3) according to the frequency required by an application while the frequency of the high band can be designed from the length of the resonance branch A (2) according to the frequency required by an application.

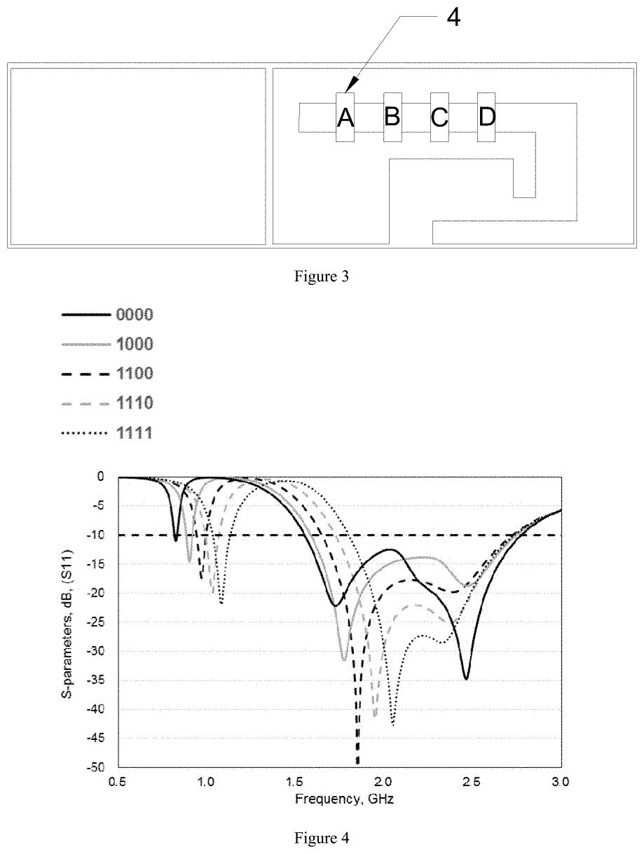

Referring to FIGS. 3 and 4, in embodiment 2, four sets of tuning circuits (4) are also provided between the resonance branch A (2) and the resonance branch B (3), which may be of radio frequency switching circuits, as shown in Table 2 and FIG. 4,

TABLE 2
FM circuit status

| | Tuning | Tuning | Tuning | Tuning |
|---|---|---|---|---|
| Antenna | circuit A | circuit B | circuit C | circuit D |
| 0000 | Off | Off | Off | Off |
| 1000 | On | Off | Off | Off |
| 1100 | On | Off | Off | Off |
| 1110 | On | On | On | Off |
| 1111 | On | On | On | On |

FIG. 4 illustrates the antenna S-parameter (S₁₁) in different states of the tuning. It can be seen that after the tuning circuits (4) are added, the working frequency of the antenna undergoes changes, the antenna efficiency is improved, and the transmission and reception effects are better.

For those skilled in the art, apparently the present utility model is not limited to the details given in the above exemplary embodiments. The present utility model can be embodied in other specific forms without departing from the spirit or essential characteristics of the utility model. Therefore, the embodiments shall be considered as exemplary and unrestricted in any way. The scope of the utility model is defined by the appended claims rather than the above description. Hence, all changes intended to come within the meaning and range of equivalent elements of the claims shall be included within the utility model. Any marks on drawings to the Claims shall not be construed as limiting the Claims involved.

Furthermore, it shall be understood that although the Specification is described in terms of embodiments, not every embodiment includes only one independent technical scheme. The description style in the Specification is for clarity only. Those skilled in the art shall take the Specification as a whole. The technical schemes in various embodiments may also be combined as appropriate to form other embodiments that can be understood by those skilled in the art.

1. An adjustable multi-band planar antenna comprising a ground plane, a resonance branch A, and a resonance branch B, wherein the ground plane, the resonance branch A, and the resonance branches B are all disposed on the top surface of a PCB; and the resonance branch A and the resonance branch B assume an “L” shape.

2. An adjustable multi-band planar antenna according to claim 1, wherein four sets of tuning circuits are located between the resonance branch A, and the resonance branch B.

3. An adjustable multi-band planar antenna according to claim 2, wherein the tuning circuit is of a radio frequency switching circuit.

4. An adjustable multi-band planar antenna according to claim 1, wherein a circuit is provided at the bottom of the ground plane.
